(19) United States
(12) Patent Application Publication
(10) Pub. No.: US 2026/0037735 A1
(43) Pub. Date: Feb. 5, 2026

(54) METHOD AND DEVICE FOR PROVIDING COLOR THAT MATCHES INTENT OF USER'S UTTERANCE

(71) Applicants: HYUNDAI MOTOR COMPANY, Seoul (KR); KIA CORPORATION, Seoul (KR)

(72) Inventor: Jang Sun Lee, Hwaseong-si (KR)

(73) Assignees: HYUNDAI MOTOR COMPANY, Seoul (KR); KIA CORPORATION, Seoul (KR)

(21) Appl. No.: 19/060,163

(22) Filed: Feb. 21, 2025

(30) Foreign Application Priority Data
Aug. 1, 2024 (KR) 10-2024-0102712

(51) Int. Cl. G06F 40/30

(52) U.S. Cl. CPC G06F 40/30

(57) ABSTRACT

A method and device provide a color that matches an intent of a user's utterance. The method includes: generating one or more second natural language expressions, each corresponding to a color represented by each of first color codes, for one or more of the first color codes in a pre-created table; and generating a response based on a result of interpreting the user's utterance related to the color.

### CROSS-REFERENCE TO RELATED APPLICATION

This application claims the benefit of and priority to Korean Patent Application No. 10-2024-0102712, filed on Aug. 1, 2024, the entire contents of which are incorporated herein by reference.

### TECHNICAL FIELD

The present disclosure relates to a method and device for providing a color that matches an intent of a user's utterance.

### BACKGROUND

The content described below merely provides background information related to the present disclosure and does not constitute prior art.

A speech recognition system classifies a domain of a user's utterance based on the user's utterance, identifies the utterance intent, and extracts an entity name. Once the existing speech recognition system obtains utterance of a user related to a color, the existing speech recognition system extracts the entity name for the color from the utterance of the user to find out the color code of the color desired by the user, determines whether the entity name for the extracted color is included among natural language expressions in a pre-defined table, and provides the user with a response that the color cannot be found when the entity name for the extracted color is not included among natural language expressions in the pre-defined table.

There are cases where the entity name for a color included in the user's utterance is not included among the natural language expressions in the pre-defined table. Therefore, a method and device are needed to add natural language expressions corresponding to each color code for each color code and to determine whether the entity name for the color is included not only in the natural language expressions in the pre-defined table but also in the added natural language expressions.

The same color may be expressed differently by each user. Even when natural language expressions corresponding to each color code are added, the entity name for the color included in the user's utterance may not be included in any of the natural language expressions in the pre-defined table or the added natural language expressions. Even when the entity name for the color is not included in any of the natural language expressions, the user may want to receive a response based on the most similar color instead of a response that the color cannot be found. Therefore, even when the entity name for the color is not included in the natural language expressions, a method and device are needed to generate color codes that can represent the entity name, and determine the color code that is most similar to the generated color codes among the existing color codes as the color that matches the intent of the user's utterance.

### SUMMARY

An object of the present disclosure is to provide a method and device that provides a color that matches (i.e., that is consistent with) an intent of a user's utterance. Specifically, the object of the present disclosure is to provide a method and device for providing a color that matches the intent of a user's utterance by generating color codes that can represent the entity name for the color and determining a color code that is most similar to the generated color codes among the existing color codes as a color code that matches the intent of a user's utterance, even when the entity name for a color in the user's utterance is not included in any of the pre-defined natural language expressions which are pre-defined along with the existing color codes or newly defined natural language expressions.

The technical objects of the present disclosure are not limited to those described above, and other technical objects not mentioned above should be understood clearly by those having ordinary skill in the art from the descriptions given below.

According to an aspect of the present disclosure, a method for providing a color that matches an intent of a user's utterance includes: generating one or more second natural language expressions, each corresponding to a color represented by each of first color codes, for one or more of the first color codes in a pre-created table; and generating a response based on a result of interpreting the user's utterance related to the color.

According to another aspect of the present disclosure, a device for providing a color that matches an intent of a user's utterance includes: at least one memory storing commands; and at least one processor. In particular, the at least one processor executes the commands to perform: generating one or more second natural language expressions, each corresponding to a color represented by each of first color codes, for one or more of the first color codes in a pre-created table; and generating a response based on a result of interpreting the user's utterance related to the color.

According to one embodiment of the present disclosure, natural language expressions corresponding to each color code are added for each color code and it is determined whether the entity name for the color is included in the added natural language expressions as well as the natural language expressions in the pre-defined table, thereby providing a color that matches the intent of a user's utterance.

According to one embodiment of the present disclosure, even when the entity name for the color is not included in the natural language expressions, color codes that can represent the entity name are generated, and a color code most similar to the generated color codes among the existing color codes is determined as the color that matches the intent of a user's utterance, thereby providing a color that matches the intent of a user's utterance.

The technical effects of the present disclosure are not limited to the technical effects described above, and other technical effects not mentioned herein should be understood to those having ordinary skill in the art to which the present disclosure belongs from the description below.

### BRIEF DESCRIPTION OF THE DRAWINGS

FIG. 1 is a drawing schematically illustrating the configuration of a device for providing a color that matches an intent of a user's utterance according to one embodiment of the present disclosure.

FIG. 2 is a flowchart schematically illustrating a method for providing the color that matches the intent of a user's utterance according to one embodiment of the present disclosure.

FIG. 3 is a diagram schematically illustrating a configuration of an example of a computing device that can be used to implement the devices and methods described in the present disclosure.

The drawings described herein are for illustration purposes only and are not intended to limit the scope of the present disclosure in any way.

### DETAILED DESCRIPTION

Hereinafter, some embodiments of the present disclosure are described in detail using drawings. When adding reference symbols to components of each drawing, it should be noted that the same components are given the same symbols as much as possible even when they are illustrated in different drawings. In addition, when describing the present disclosure, when it is determined that a specific description of a related known configuration or function may obscure the gist of the present disclosure, the detailed description thereof has been omitted.

When describing components of an embodiment according to the present disclosure, symbols such as first, second, i), ii), a), b), and the like may be used. These symbols are only intended to distinguish the components from other components, and the nature, order, or sequence of the corresponding components is not limited by the symbols. When a part of the specification is said to “include” or “have” a component, this does not mean that other components are excluded, but rather that other components may be included, unless explicitly stated otherwise.

When a component, processor, device, element, apparatus, or the like of the present disclosure is described as having a purpose or performing an operation, function, or the like, the component, processor, device, element, apparatus, or the like should be considered herein as being “configured to” meet that purpose or to perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

The detailed description set forth below, together with the accompanying drawings, is intended to describe embodiments of the present disclosure, and is not intended to represent the only embodiments in which the present disclosure may be practiced.

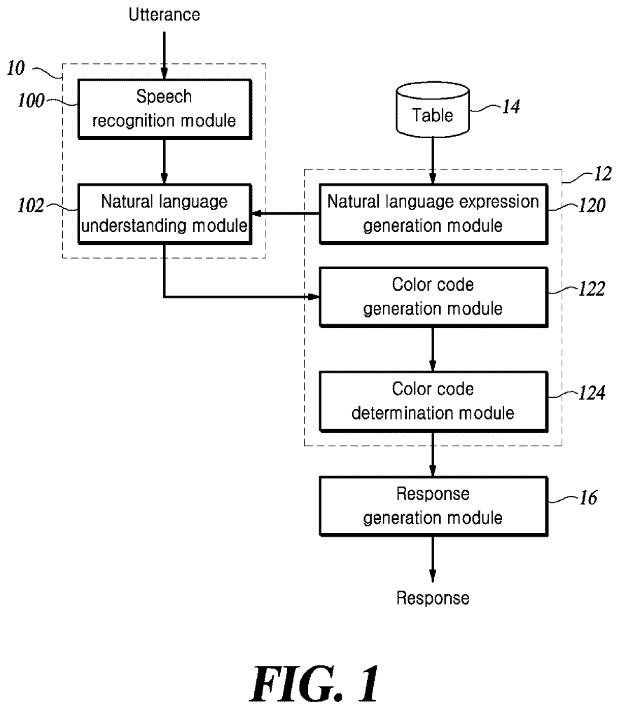

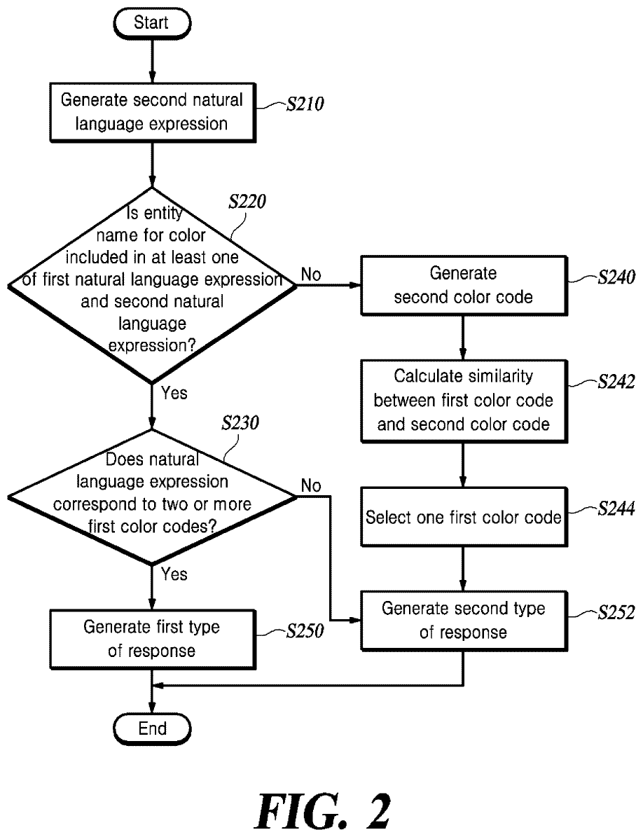

FIG. 1 is a drawing schematically illustrating the configuration of a device for providing a color that matches an intent of a user's utterance according to one embodiment of the present disclosure. FIG. 2 is a flowchart schematically illustrating a method for providing the color that matches the intent of a user's utterance according to one embodiment of the present disclosure.

Referring to FIG. 1, the device providing a color that matches the intent of a user's utterance according to one embodiment of the present disclosure may include a speech recognition system 10, a color matching system 12, a table 14, and a response generation module 16.

The speech recognition system 10 may include a speech recognition module 100 and a natural language understanding module 102.

The speech recognition module 100 may obtain user's utterance and convert the user's utterance into an input sentence using one or more speech to text (STT) engines. The STT engine may apply one or more of a speech recognition algorithm and a deep learning model to a speech signal representing the user's utterance to convert the speech signal into text. For example, the speech recognition module 100 can extract a feature vector from the user's utterance by applying a feature vector extraction technique such as Cepstrum, Linear Predictive Coefficient (LPC), Mel Frequency Cepstral Coefficient (MFCC), and Filter Bank Energy. The speech recognition module 100 may obtain a recognition result by comparing the extracted feature vector with a trained reference pattern. For this purpose, one or more of an acoustic model (AM) that models and compares signal characteristics of speech and a language model (LM) that models the linguistic order relationship of words or syllables corresponding to a recognition vocabulary may be used. The speech recognition module 100 may preprocess a speech signal representing the user's utterance before speech recognition. For example, the speech recognition module 100 may perform preprocessing to reduce noise in a speech signal representing the user's utterance before speech recognition.

The natural language understanding module 102 may classify the domain of the user's utterance from the input sentence, identify the utterance intent, and extract the entity name using at least one natural language understanding (NLU) engine. The natural language understanding module 102 may segment the input sentence into tokens of morpheme units and project the tokens onto a vector space. One or more of the tokens or a combination thereof may be converted into an embedding vector. The natural language understanding module 102 may identify the intent of the user's utterance based on the embedding vectors and extract the entity name. The natural language understanding module 102 can extract the entity name for the color included in the user's utterance. For example, when the user's utterance is “change an indoor mood lighting to burgundy”, the natural language understanding module 102 may identify the intent of a user's utterance as “change the indoor mood lighting” and extract the entity name “burgundy” for the color. As another example, when the user's utterance is “change the indoor mood lighting to red”, the natural language understanding module 102 may identify the intent of the user's utterance as “change the indoor mood lighting” and extract the entity name “red” for the color. As the other example, when the user's utterance is “change the indoor mood lighting to a reddish color”, the natural language understanding module 102 may identify the intent of the user's utterance as “change the indoor mood lighting” and extract the entity name “reddish color” for the color.

The color matching system 12 may include a natural language expression generation module 120, a color code generation module 122, and a color code determination module 124. Each of the natural language expression generation module 120, the color code generation module 122, and the color code determination module 124 may be implemented using one or more language models (LMs). The language models may be large language models (LLMs). Each module may be implemented using one large language model, or may be implemented using multiple large language models tuned for each module. The large language models may include a transformer model and a generative pre-trained transformer (GPT) model.

The natural language expression generation module 120 may obtain the table 14. The table 14 is pre-created data and may include color codes and pre-defined natural language expressions for each color code. The color codes can be hex color codes. Table 1 illustrates the table 14 according to one embodiment of the present disclosure.

TABLE 1

| First Color Code | First Natural Language Expression |
|---|---|
| #EBFAFF | Aquamarine White |
| #F9F7ED | Pearl White |
| #FFB805 | Topaz Yellow |
| #C0504D | Sard Brown |
| #CC0066 | Garnet Red |
| #9900CC | Amethyst Purple |
| #542DA3 | Sapphire Violet |
| #114ABD | Zircon Blue |
| #0BC1B0 | Emerald Blue Green |
| #84F513 | Peridot Green |

Referring to Table 1, color codes for ten colors and natural language expressions for each color code are sorted and stored in table 14. There may be only one natural language expression for each color code.

The natural language expression generation module 120 may generate one or more natural language expressions based on the color codes in the acquired table 14, i.e., the first color codes (an operation S210). The natural language expression generation module 120 may generate one or more natural language expressions for each color code. The one or more natural language expressions generated by the natural language expression generation module 120 can include natural language expressions pre-defined in the table 14. In other words, among the one or more natural language expressions generated by the natural language expression generation module 120, there may be an expression that is identical to the natural language expressions pre-defined in the table 14.

Table 2 illustrates some of the natural language expressions generated by the natural language expression generation module 120 according to one embodiment of the present disclosure.

TABLE 2

| | First Natural | Second Natural |
|---|---|---|
| | Language | Language |
| First Color Code | Expression | Expression |
| #C0504D | Sard Brown | Brick Red |
| | | Rusty Red |
| | | Terra Cotta |
| | | Burnt Sienna |
| | | Copper Red |
| | | Mahogany Red |
| | | Clay Red |
| | | Rust Red |
| | | Earthy Red |
| | | Burgundy Red |

Referring to Table 2, ten pre-defined first natural language expression for the color code of #C0504D and ten newly generated second natural language expressions based on the color code of #C0504D are stored in table 14. One or more second natural language expressions can be generated for each color code.

The natural language understanding module 102 may obtain first natural language expression which are pre-defined and second natural language expressions which are newly generated from the natural language expression generation module 120. The natural language understanding module 102 determines whether the entity name for the extracted color is included in at least one of the obtained natural language expressions, i.e., the first natural language expression or the second natural language expressions (an operation S220). For example, when the entity name for the extracted color is “burgundy”, it can be determined that the entity name for the extracted color is included in at least one of the first natural language expression or the second natural language expressions, as “burgundy” corresponds to “Burgundy Red” among the second natural language expressions. As another example, when the entity name for the extracted color is “red”, it can be determined that the entity name for the extracted color is included in at least one of the first natural language expression or the second natural language expression, as “red” corresponds to “Garnet Red” in the first natural language expression, and to “Brick Red”, “Rusty Red”, “Copper Red”, “Mahogany Red”, “Clay Red”, “Rust Red”, ‘Earthy Red”, and “Burgundy Red” in the second natural language expressions. As the other example, when the entity name for the extracted color is “reddish color”, it can be determined that the entity name for the extracted color is not included in any of the first natural language expression and the second natural language expression, as “reddish color” does not correspond to any of the first natural language expression and the second natural language expression.

The color code generation module 122 determines whether the natural language expressions including the entity name for the color correspond to two or more first color codes when the entity name for the color is included in at least one of the first natural language expression or the second natural language expressions (an operation S230). For example, when the entity name for the extracted color, “burgundy”, corresponds to “Burgundy Red” which is included in the second natural language expressions, it can be determined that natural language expressions including the entity name for the color do not correspond to two or more first color codes, as the only one first color code, #C0504D, corresponds to “Burgundy Red”. As another example, when the entity name for the extracted color, “red”, corresponds to “Garnet Red”, “Brick Red”, “Rusty Red”, “Copper Red”, “Mahogany Red”, “Clay Red”, “Rust Red”, “Earthy Red”, and “Burgundy Red”, which are included in both the first natural language expression and the second natural language expressions, it can be determined that natural language expressions including the entity name for color correspond to two or more first color codes, as each color code of two first color codes, #CC0066 and #C0504D, corresponds to “Garnet Red” and “Brick Red”, “Rusty Red”, “Copper Red”, “Mahogany Red”, “Clay Red”, “Rust Red”, “Earthy Red’, and “Burgundy Red”, respectively.

The color code generation module 122 generates one or more color codes based on the entity name for the color when the entity name for the color is not included in any of the first natural language expression and the second natural language expressions (an operation S240). For example, when the entity name for the extracted color is “reddish color” and therefore none of the first natural language expression and the second natural language expressions correspond to the “reddish color,” the color code generation module 122 may generate color codes that can represent the “reddish color”. Table 3 illustrates color codes generated by the color code generation module 122 according to one embodiment of the present disclosure. The color codes may be hex color codes.

TABLE 3

| Entity Name for Color | Second Color Code |
|---|---|
| Reddish Color | #C04F4B |
| | #BF504E |
| | #C04D4A |
| | #C14F4C |
| | #C14D49 |
| | #BF514D |
| | #C24E4B |
| | #BF4D49 |
| | #C24F4C |
| | #BE514D |

Referring to Table 3, ten second color codes generated for “reddish color” are illustrated. The number of color codes generated can be arbitrarily specified.

The color code determination module 124 can calculate a similarity between the first color code and the second color code (an operation S242). The similarity may be cosine similarity. For example, referring to Table 1 and Table 3, the color code determination module 124 can calculate the cosine similarity between each of the ten first color codes illustrated in Table 1 and each of the ten second color codes illustrated in Table 3. The color code determination module 124 may calculate the average similarity between each first color code and all second color codes. In other words, for each first color code, the color code determination module 124 may calculate the average similarity with all second color codes, resulting in an average similarity value for each first color code. For example, by averaging the ten similarity values calculated between the first color code #EBFAFF and the second color codes, the average similarity for the first color code #EBFAFF with the second color codes may be extracted. Table 4 is a table illustrating the results of extracting the average similarity for each first color code with the second color codes according to one embodiment of the present disclosure.

TABLE 4

| First Color Code | Average Similarity |
|---|---|
| #EBFAFF | 0.125 |
| #F9F7ED | 0.153 |
| #FFB805 | 0.349 |
| #C0504D | 0.957 |
| #CC0066 | 0.845 |
| #9900CC | 0.496 |
| #542DA3 | 0.426 |
| #114ABD | 0.248 |
| #0BC1B0 | 0.267 |
| #84F513 | 0.212 |

Referring to Table 4, the average similarity between the ten first color codes and the second color code extracted for each first color code is illustrated.

The color code determination module 124 may determine the first color code having the highest average similarity as the color code that matches the intent of the user's utterance (an operation S244). For example, referring to Table 4, the color code determination module 124 may determine #C0504D having the highest average similarity of 0.957 as the color code that matches the intent of the user's utterance. In other words, the device for providing a color that matches the intent of the user's utterance according to one embodiment of the present disclosure may correspond #C0504D having the highest average similarity of 0.957 to the “reddish color” intended by the user.

The response generation module 16 may generate a response that matches the intent of the user's utterance. The response may include different types of responses. The response may be provided using an audio video navigation telematics technology when the method of providing a color that matches the intent of the user's utterance according to one embodiment of the present disclosure is performed in a vehicle.

When the entity name for the color is included in at least one of the first natural language expression or the second natural language expressions, and the natural language expressions including the entity name for the color correspond to two or more first color codes, the response generation module 16 generates a first type of response (an operation S250). The first type of response may be a question to the user. For example, when the user's utterance is “change the indoor mood lighting to red,” the response generation module 16 may ask the user which color the user wants between #CC0066 and #C0504D. The response generation module 16 may generate the question using the first natural language expression corresponding to the first color codes. The response generation module 16 may ask the user “which color do you want to change to between Garnet Red and Sard Brown?”.

When the entity name for the color is included in at least one of the first natural language expression or the second natural language expressions, and the natural language expressions including the entity name for the color do not correspond to two or more first color codes, the response generation module 16 generates a second type of response (an operation S252). For example, when the user's utterance is “change the indoor mood lighting to burgundy,” the response generation module 16 may change the color of the indoor mood lighting to #C0504D. The device for providing a color that matches the intent of the user's utterance according to one embodiment of the present disclosure may provide a color that matches the intent of the user's utterance by changing the color of the indoor mood lighting. When the entity name for the color is not included in any of the first natural language expression and the second natural language expressions, and therefore one first color code is determined based on the similarity between the first color code and the second color code, the response generation module 16 generates a second type of response (the operation S252). The second type of response may be the performance of an action corresponding to the user's request. For example, when the user's utterance is “change the indoor mood lighting to a reddish color,” the response generation module 16 may change the color of the indoor mood lighting to #C0504D. The device for providing a color that matches the intent of the user's utterance according to one embodiment of the present disclosure may provide a color that matches the intent of the user's utterance by changing the color of the indoor mood lighting. Even when the entity name “reddish color” for the color in the user's utterance is not included in any of first natural language expression which is pre-defined for first color codes and second natural language expressions which are newly generated based on the first color codes, the device for providing a color that matches the intent of the user's utterance according to one embodiment of the present disclosure can provide a color that matches the intent of the user's utterance by generating one or more second color codes that can represent a “reddish color” using the language model, selecting one first color code that is most similar to the second color codes among the first color codes, and generating a second type of response based on the selected first color code.

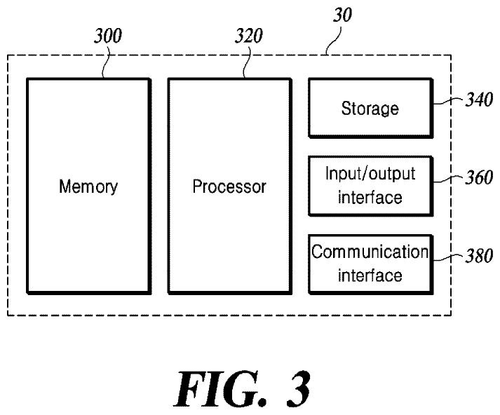

FIG. 3 is a diagram schematically illustrating a configuration of an example of a computing device that can be used to implement the devices and method described in the present disclosure.

A computing device 30 may include some or all of a memory 300, a processor 320, storage 340, an input/output interface 360, and a communication interface 380. The computing device 30 may be a stationary computing device, such as a desktop computer or a server, as well as a mobile computing device, such as a laptop computer or a smartphone. The computing device 30 may include any specialized hardware accelerator capable of efficiently processing operations for an artificial intelligence model. For example, the computing device 30 may include a graphic processing unit (GPU), a tensor processing unit (TPU), or a neural processing unit (NPU).

The memory 300 can store a program that causes the processor 320 to perform a method or operation according to various embodiments of the present disclosure. For example, the program can include a plurality of commands executable by the processor 320, and the above-described method or operation can be performed by executing the plurality of commands by the processor 320. The memory 300 can be a single memory or a plurality of memories. In this case, information necessary for performing the method or operation according to various embodiments of the present disclosure can be stored in a single memory or divided and stored in a plurality of memories. When the memory 300 is composed of a plurality of memories, the plurality of memories can be physically separated. The memory (300) can include at least one of a volatile memory or a nonvolatile memory. The volatile memory includes a static random access memory (SRAM) or a dynamic random access memory (DRAM), and the nonvolatile memory includes a flash memory.

The processor 320 may include at least one core capable of executing at least one command. The processor 320 may execute commands stored in the memory 300. The processor 320 may be a single processor or multiple processors.

The storage 340 maintains stored data even when power supplied to the computing device 30 is cut off. For example, the storage 340 may include nonvolatile memory, and may include storage media such as magnetic tape, optical disk, and magnetic disk. A program stored in the storage 340 may be loaded into the memory 300 before being executed by the processor 320. The storage 340 may store a file written in a programming language, and a program generated from the file by a compiler or the like may be loaded into the memory 300. The storage 340 may store data to be processed by the processor 320 and/or data processed by the processor 320.

The input/output interface 360 may provide an interface with an input device such as a keyboard, mouse, and the like and/or an output device such as a display device, printer, and the like. A user may trigger execution of a program by the processor 320 through an input device and/or check the processing result of the processor 320 through an output device.

The communication interface 380 may provide access to an external network. The computing device 30 can communicate with other devices through the communication interface 380.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claims. Therefore, embodiments of the present disclosure have been described for the sake of brevity and clarity. The scope of the technical idea of the present embodiments is not limited by the illustrations. Accordingly, one of ordinary skill would understand that the scope of the claims is not to be limited by the above explicitly described embodiments but by the claims and equivalents thereof.

What is claimed is:

1. A method for providing a color that matches an intent of a user's utterance, the method comprising:
generating one or more second natural language expressions, each corresponding to a color represented by each of first color codes, for one or more of the first color codes in a pre-created table; and
generating a response based on a result of interpreting the user's utterance related to the color.

2. The method of claim 1, wherein generating the response includes:
generating one or more second color codes based on the result of interpreting the user's utterance related to the color.

3. The method of claim 2, wherein generating the response further includes:
determining one color code that matches the intent of the user's utterance among the first color codes, based on a similarity between the first color codes and the one or more second color codes.

4. The method of claim 3, wherein determining the one color code that matches the intent of the user's utterance includes:
calculating similarities between each of the first color codes and each of the second color codes;
calculating an average of the similarities for each of the first color codes; and
selecting the first color code with having a highest average value as the one color code that matches the intent of the user's utterance.

5. The method of claim 1, wherein generating the response includes:
generating the response based on whether an entity name for a color among one or more entity names included in the result of interpreting the user's utterance related to the color is included in at least one of a first natural language expression which are pre-defined for the first color codes or the one or more second natural language expressions which are newly generated.

6. A device for providing a color that matches an intent of a user's utterance, the device comprising:
at least one memory storing commands; and
at least one processor,
wherein the at least one processor is configured to execute the commands to perform:
generating one or more second natural language expressions, each corresponding to a color represented by each of first color codes, for one or more of the first color codes in a pre-created table, and
generating a response based on a result of interpreting the user's utterance related to the color.

7. The device of claim 6, wherein generating the response includes:
generating one or more second color codes based on the result of interpreting the user's utterance related to the color.

8. The device of claim 7, wherein generating the response further includes:
determining one color code that matches the intent of the user's utterance among the first color codes, based on a similarity between the first color codes and the one or more second color codes.

9. The device of claim 8, wherein determining of the one color code that matches the intent of the user's utterance includes:
calculating similarities between each of the first color codes and each of the second color codes;
calculating an average of the similarities for each of the first color codes; and
selecting the first color code with having a highest average value as the one color code that matches the intent of the user's utterance.

10. The device of claim 6, wherein generating the response includes:
generating the response based on whether an entity name for a color among one or more entity names included in the result of interpreting the user's utterance related to the color is included in at least one of a first natural language expression which are pre-defined for the first color codes or the one or more second natural language expressions which are newly generated.
